(19) United States
(12) Patent Application Publication
(10) Pub. No.: US 2015/0328618 A1
(43) Pub. Date: Nov. 19, 2015

(54) REACTOR FOR PRODUCING OR TREATING A POLYMER MELT

(71) Applicant: Technip Zimmer GmbH, Frankfurt am Main (DE)

(72) Inventors: Ludwig Hölting, Brucköbel (DE); Heinz Lehn, Frankfurt a. M. (DE)

(21) Appl. No.: 14/647,118

(22) PCT Filed: Nov. 22, 2013
(86) PCT No.: PCT/EP2013/074484

§ 371 Date: May 25, 2015

(30) Foreign Application Priority Data
Nov. 26, 2012 (DE) 10 2012 111 445.5

(51) Int. Cl. B01J 19/24; C08G 63/183

(52) U.S. Cl. CPC B01J 19/24; C08G 63/183; B01J 2219/24; B01J 2219/00252

(57) ABSTRACT

A reactor for producing or treating a polymer melt, comprising a bottom valve via which the polymer melt can be discharged from the reactor, wherein the bottom valve comprises a valve seat and a closing body which can form a common sealing surface.

### FIELD OF THE INVENTION

This invention relates to a reactor for producing or treating a polymer melt, comprising a bottom valve via which the polymer melt can be discharged from the reactor.

### PRIOR ART

In the molten condition, many polymers are very temperature- and retention-time-sensitive, i.e. they very quickly change their chemical and rheological properties, in particular at high temperatures. At the same time, these melts often have a high dynamic viscosity, whereby the homogenization of the melt for example by stirring becomes difficult. Due to these material properties it is required that reactors for the treatment of these melts are designed such that the polymer is uniformly exposed to the reaction conditions and that in the reactor and its feed and discharge lines no dead zones rather are present, in which polymer can deposit. One measure to avoid dead zones consists in replacing the shut-off valve normally present in the discharge line for discharging the polymer melt from the reactor by a bottom valve in the reactor bottom.

Such reactor is known from the Chinese Utility Model Specification CN 201485407 U. It is described there for the polymerization of styrene to EPS (expanded polystyrene).

In the design disclosed in this specification it is disadvantageous that this bottom valve has no valve seat normally present in valves, against which the closing body might be pressed for closing the valve. The closing body instead is moved in the valve housing in the manner of a piston. Since a clearance must be present between closing body and valve housing, in order to keep the closing body movable in the valve housing, a certain leakage rate will be inevitable in this construction and there is a risk that polymer is deposited in this space and hardens there and thus blocks the piston.

Therefore, it is the object of the present invention to provide a reactor in which the disadvantages of the prior art are avoided.

### DESCRIPTION OF THE INVENTION

The present invention solves the object in that the reactor for producing or treating a polymer melt according to the invention includes a bottom valve, via which the polymer melt is discharged from the reactor. This bottom valve comprises a closing body and is equipped with a valve seat against which the closing body can be pressed, wherein both parts form a common sealing surface by which the valve is closed.

The reactor according to the invention provides for draining the produced or treated polymer melt without the occurrence of disturbing side or post-reactions or cloggings. This is due to the minimization of possible dead zones.

### PREFERRED ASPECTS OF THE INVENTION

A preferred aspect of the invention consists in forming the sealing surface with a conical design. The valve seat and the closing body thereby are guided into the exact, centered position, when they are moved towards each other for closing the valve. Due to the conical design, both parts in addition can be separated from each other more easily for opening the valve, in particular when polymer residues possibly have got to the sealing surface and have led to valve seat and closing body sticking together.

In a further preferred aspect of the invention the wall of the inlet opening of the valve directly serves as valve seat. Due to this measure, the valve seat otherwise placed in the interior of the valve body is eliminated and the polymer flow through the valve no longer is impeded by the valve seat. In addition, there are no dead zones usually occurring at such flow obstacles, and the cleaning effort caused by the same is eliminated.

In a further preferred aspect of the invention the closing body is arranged relative to the valve seat such that in the closed condition of the bottom valve the upper side of the closing body terminates with the inner wall of the reactor and in the open condition the closing body at least partly protrudes into the reactor interior. The advantage of this aspect consists in that in the open condition of the bottom valve the polymer flows through below the closing body into the discharge line. The formation of a dead zone at the bottom side of the closing body thus largely is avoided.

To additionally counteract the risk of the formation of a dead space at the bottom side of the closing body, the bottom side of the closing body can be equipped with a displacer or be formed as displacer in a further preferred aspect of the invention.

A further preferred aspect is characterized in that the valve seat is arranged such that for closing the valve the closing body is pressed against the valve seat against the flow direction of the polymer stream discharged from the reactor. Due to this design, a self-sealing effect is achieved for the function of the valve, when the reactor is operated with negative pressure.

The reactor according to the invention is particularly suitable for the production or treatment of polymer melts, such as polyalkylene terephthalates and in particular polyethylene terephthalate, polybutylene terephthalate or polytrimethylene terephthalate. In these polymers the temperature and retention-time sensitivity is particularly pronounced, so that in the construction of the reactors greatest care must be taken to avoid dead zones.

This sensitivity of these polymers is the more pronounced the further the polymerization has advanced. In addition, with increasing degree of polymerization the dynamic viscosity of the melt also is increasing, whereto by the homogenization of the melt and the avoidance of dead zones is made even more difficult. When the polymerization is carried out in a reactor cascade, the reactor according to the invention therefore is particularly suitable for the use as end reactor of the cascade.

### EXEMPLARY EMBODIMENTS

Further developments, advantages and possible applications of the invention can also be taken from the following description and the drawing. All features described and/or illustrated form the subject-matter of the invention per se or in any combination, independent of their inclusion in the claims or their back-reference.

The invention will now be explained with reference to the drawings. The drawings show exemplary embodiments for bottom valves, each incorporated in a reactor according to the invention. In the drawings:

FIG. 1 shows the fundamental operating principle of the bottom valve in the reactor according to the invention,

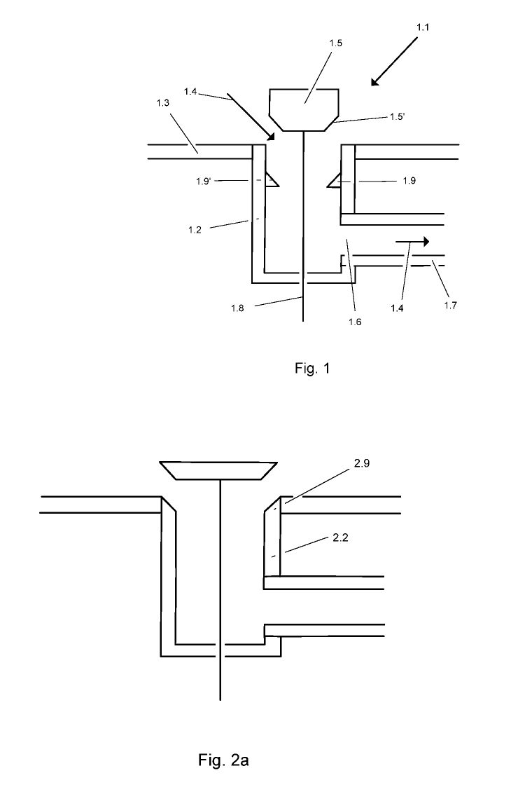

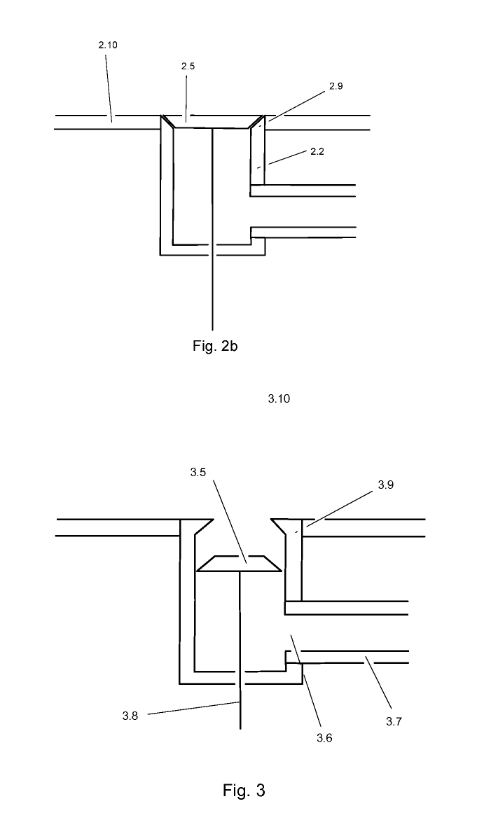

FIGS. 2a, b show a bottom valve with valve seat integrated into the inlet opening in the open and closed condition,

FIG. 3 shows a bottom valve with valve seat mounted towards the reactor interior,

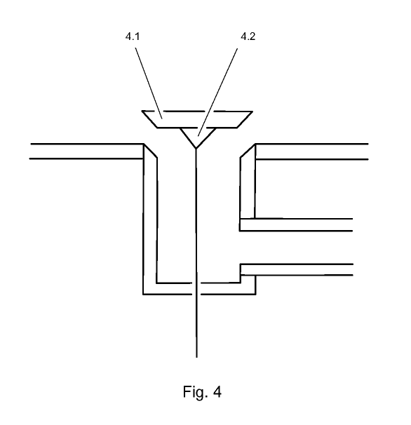

FIG. 4 shows a bottom valve with displacer.

With reference to FIG. 1 the operating principle will now be explained. The valve body 1.2 of the bottom valve 1.1 is directly incorporated into the wall 1.3 of the reactor bottom and connected with the same, for example by a welded joint. Protrusions which extend into the reactor interior largely are avoided during installation. The drawing shows the valve in the open condition. The polymer melt 1.4 flows around the closing body 1.5, through the valve body 1.2 and leaves the bottom valve 1.1 through the valve outlet opening 1.6 into the discharge line 1.7.

For opening and closing the valve, the closing body 1.5 is vertically moved by the valve rod 1.8. For closing the valve, the closing body 1.5 is pressed against the valve seat 1.9 with its bottom side. In this example, the sealing surfaces of the closing body 1.5′ and of the valve seat 1.9′ contacting each other have a conical design. For opening the valve, the separation of the sealing surfaces thereby can be facilitated. The valve rod can be actuated mechanically, electromagnetically or pneumatically.

In FIG. 2, the upper side of the closing body directed towards the reactor interior is shown flat, but when it is regarded as favorable in terms of flow, it can also be formed with another shape, e.g. oval or hemispherical.

FIGS. 2a and b show a preferred embodiment of the invention in which the valve seat 2.9 is directly integrated into the inlet opening of the valve body 2.2. The advantage of this embodiment consists in that it has no valve seat placed in the valve body, by which the discharge of the polymer is impeded. Thus, the polymer deposits preferably occurring at such flow obstacles are avoided.

FIG. 2b shows how in this embodiment in the closed condition the upper side of the closing body 2.5 terminates with the wall of the reactor bottom 2.10.

The embodiments of the reactor according to the invention as shown in FIG. 1 and FIG. 2 are suitable in particular when an excess pressure exists in the reactor with regard to the pressure in the discharge line. The bottom valve then has a self-sealing effect, since the closing body is pressed against the valve seat due to the excess pressure.

FIG. 3 shows a further preferred embodiment of the invention. Here, the valve seat 3.9 and the closing body 3.5 are arranged such that for closing the valve the closing body 3.5 must be pressed against the valve seat 3.9 in direction of the reactor interior 3.10. When the reactor is operated with negative pressure, a self-sealing effect is achieved by this arrangement. This can be the case when the polymer in the reactor is treated under vacuum conditions, for example for degassing. For opening the valve, the closing body 3.5 is pulled downwards by means of the valve rod 3.8 beyond the outlet opening 3.6, so that the polymer can get into the discharge line 3.7 unimpededly.

FIG. 4 shows an embodiment of the invention in which the closing body 4.1 of the bottom valve is equipped with a displacer 4.2 on its bottom side.

Reactors according to the invention are particularly suitable for use in methods for the production and treatment of polymers on the basis of polyalkylene terephthalate, such as polyethylene terephthalate, polybutylene terephthalate or polytrimethylene terephthalate. Due to their high sensitivity to temperature and retention time influences, and due to their high dynamic viscosity, it is particularly important in these polymers to avoid dead zones, as they occur in valves, which conventionally are placed in the discharge line.

### INDUSTRIAL APPLICABILITY

Thus, a reactor is provided with the invention, which provides for omitting a closing valve tending to be soiled in the polymer discharge line. The cleaning effort thereby is reduced and the efficiency of the reactor and the method is improved.

### LIST OF REFERENCE NUMERALS

1.1 bottom valve
1.2 valve body
1.3 wall of the reactor bottom
1.4 flow of the polymer melt
1.5 closing body
1.6 valve outlet opening
1.7 discharge line for polymer melt
1.8 valve rod
1.9 valve seat
2.2 valve body
2.5 closing body
2.9 valve seat
2.10 wall of the reactor bottom
3.5 closing body
3.6 outlet opening
3.7 discharge line for polymer melt
3.8 valve rod
3.9 valve seat
3.10 reactor interior
4.1 closing body
4.2 displacer

1-8. (canceled)

9. A reactor for producing or treating a polymer melt, comprising a bottom valve via which the polymer melt can be discharged from the reactor, wherein the bottom valve comprises a closing body, characterized in that the bottom valve comprises a valve seat which can form a common sealing surface with the closing body.

10. The reactor according to claim 9, characterized in that the sealing surface is formed with a conical design.

11. The reactor according to claim 9, characterized in that the wall of the inlet opening of the valve serves as valve seat.

12. The reactor according to claim 9, characterized in that the closing body is arranged relative to the valve seat such that in the closed condition of the bottom valve the upper side of the closing body terminates with the inner wall of the reactor and in the open condition the closing body at least partly protrudes into the reactor interior.

13. The reactor according to claim 12, characterized in that the closing body includes a displacer at its bottom side facing away from the polymer flow.

14. The reactor according to claim 9, characterized in that the valve seat is arranged such that for closing the valve the closing body is pressed against the valve seat against the flow direction of the polymer stream discharged from the reactor.

15. Use of a reactor according to claim 9 for the production or treatment of a polymer melt, comprising polyalkylene terephthalates.

16. The use according to claim 15, characterized in that the polyalkylene terephthalates comprise polyethylene terephthalate, polybutylene ter-ephthalate or polytrimethylene terephthalate.
